(19) United States
(12) Patent Application Publication
(10) Pub. No.: US 2017/0299476 A1
(43) Pub. Date: Oct. 19, 2017

(54) AUTOMATIC FLUID SAMPLING SYSTEM WITH CONFIRMATION FEEDBACK

(71) Applicant: L B FOSTER COMPANY, Pittsburgh, PA (US)

(72) Inventor: Jason Strawn, Willis, TX (US)

(21) Appl. No.: 15/458,789

(22) Filed: Mar. 14, 2017

Related U.S. Application Data
(60) Provisional application No. 62/308,150, filed on Mar. 14, 2016.

(51) Int. Cl. G01N 1/20

(52) U.S. Cl. CPC G01N 1/2035; G01N 2001/205

(57) ABSTRACT

An automatic fluid sampling system, comprising: a sample flow-through conduit in fluid communication with a fast loop or slip stream off of a fluid process line or pipe, a solenoid or other valve disposed for regulating fluid flow from the fast loop line into the sample flow-through conduit; a flow meter in fluid communication with sample flow-through conduit for measuring a volume of a sample allowed to flow through the sample flow-through conduit by the solenoid or other valve; and a sample fluid outlet from which the sample measured by the flow meter exits the sample flow-through conduit.

### CROSS REFERENCE TO RELATED APPLICATIONS

This application claims the benefit of the filing date of U.S. provisional patent application Ser. No. 62/308,150, filed on Mar. 14, 2016, the entirety of which is incorporated herein by reference for all purposes.

### BACKGROUND

Prior art sampling devices use a positive displacement cavity or diaphragm as a means to extract a sample. Prior art sampling devices use a PLC/controller to drive (pace) the sampler but do not provide overall system performance feedback.

Operational performance issues are inevitable with all devices of all types as mechanical and/or electrical failures are unavoidable. Problems, however, exist in the oil and gas industry of malfunctioning samplers going unnoticed for extended periods of time. This issue with prior art sampling devices relates to the lack of both static and dynamic performance monitoring of the sampling device.

Remote accounting and control systems for programmable additive/injector controllers, such as those described in U.S. Pat. Nos. 5,271,526, 5,222,027, 5,118,008 the teachings of which are incorporated by reference herein, are known in the art. But before now, such systems have not been incorporated with fluid sampling devices.

### SUMMARY

One aspect of a preferred embodiment of the present disclosure comprises an automatic fluid sampling system, comprising: a sample flow-through conduit in fluid communication with a fast loop or slip stream off of a fluid process line or pipe, a solenoid or other valve disposed for regulating fluid flow from the fast loop line into the sample flow-through conduit; a flow meter in fluid communication with sample flow-through conduit for measuring a volume of a sample allowed to flow through the sample flow-through conduit by the solenoid or other valve; and a sample fluid outlet from which the sample measured by the flow meter exits the sample flow-through conduit.

In another aspect, a preferred automatic fluid sampling system of the present disclosure further comprises a computer or PLC for controlling and/or recording the actions of the solenoid valve and/or the flow meter.

In yet another aspect, a preferred automatic fluid sampling system of the present disclosure further comprises a communications device via which the computer or PLC may be programmed and/or via which the computer or PLC may transmit information such as accounting information for recordings, readings, measurements or actions taken by the system, the solenoid valve and/or flow meter.

In another aspect of a preferred automatic fluid sampling system of the present disclosure, a manifold defines the sample flow-through conduit, in-whole or in-part.

In yet another aspect of a preferred automatic fluid sampling system of the present disclosure, the information comprises or relates to one or more of the following: Power failure signal; Flushing of lines between batches; Filling progress—Sample verification; Low-flow or no-flow alarm; Over-fill warning; Sample counter; Sample container switching; Batch calculations; Batch overview report (process line metered volume (# bbl), temperature average, pressure average, bs&w average, number of samples taken, volume of samples collected); Detailed batch report (where the system is programmed to take a 1 cc sample per 5 bbl. The detailed report would produce a spreadsheet confirming when (i.e., the per bbl rate during which samples were taken); and Manual test fire button actuation.

Another aspect of a preferred embodiment of the present disclosure comprises an automatic fluid sample accounting adapter, comprising: a sample flow-through conduit in fluid communication with a fluid sampling device, wherein samples taken by the fluid sampling device are channeled through the sample flow-through conduit; a flow meter in fluid communication with sample flow-through conduit for measuring a volume of a sample channeled through the sample flow-through conduit from the fluid sampling device; and a sample fluid outlet from which the sample measured by the flow meter exits the sample flow-through conduit.

In another aspect, a preferred automatic fluid sampling system of the present disclosure further comprises a computer or PLC for controlling and/or recording the actions of the flow meter.

In yet another aspect, a preferred automatic fluid sampling system of the present disclosure further comprises a communications device via which the computer or PLC may be programmed and/or via which the computer or PLC may transmit information such as accounting information for recordings, readings, measurements or actions taken by the adapter and/or flow meter.

In another aspect, a preferred automatic fluid sampling system of the present disclosure further comprises a manifold wherein the manifold defines the sample flow-through conduit, in-whole or in-part.

In another aspect, a preferred automatic fluid sampling system of the present disclosure further comprises a manifold wherein the manifold defines the sample flow-through conduit, in-whole or in-part.

In yet another aspect of a preferred automatic fluid sampling system of the present disclosure, the information comprises or relates to one or more of the following: Power failure signal; Flushing of lines between batches; Filling progress—Sample verification; Low-flow or no-flow alarm; Over-fill warning; Sample counter; Sample container switching; Batch calculations; Batch overview report (process line metered volume (# bbl), temperature average, pressure average, bs&w average, number of samples taken, volume of samples collected); Detailed batch report (where the system is programmed to take a 1 cc sample per 5 bbl. The detailed report would produce a spreadsheet confirming when (i.e., the per bbl rate during which samples were taken); and Manual test fire button actuation.

### BRIEF DESCRIPTION OF THE DRAWINGS

FIG. 1 is a perspective view of an automatic fluid sampling system of the present disclosure.

FIG. 2 is a front plan view of a manifold of an automatic fluid sampling system of the present disclosure.

FIG. 3 is a partial front plan view of a disassembled manifold of an automatic fluid sampling system of the present disclosure.

FIG. 4 is a partial side plan view of a disassembled manifold of an automatic fluid sampling system of the present disclosure.

FIG. 5 is a partial front plan view of a partially disassembled manifold of an automatic fluid sampling system of the present disclosure.

FIG. 6 shows a preferred graphic user interface of a PLC or computer of the automatic fluid sampling system of the present disclosure.

FIG. 7 shows a perspective view of a preferred automatic fluid sampling adapter of the present disclosure for use in conjunction with another “dumb” sampling device.

### DETAILED DESCRIPTION

It should, of course, be understood that the description and drawings herein are merely illustrative and that various modifications and changes can be made in the structures disclosed without departing from the present disclosure. In the drawings hereof, like numerals refer to like parts throughout the several views.

The automatic fluid sampling system of the present disclosure preferably pertains particularly to automatic sampling for the oil and gas industry. The definition of an automatic sampling system according to the American Petroleum Institute (API), is:

“3.1.1 automatic sampling system, n—fluid sampling system that consists of: (a) flowing fluid stream conditioning, if required; (b) a means of automatically extracting a representative sample; (c) pacing of the sample extraction in a flow or time proportional manner; and (d) delivering of each extracted sample to a sample container or an analyzer.”

A preferred automatic fluid sampling system 10 of the present disclosure relates to segments (b) and (c) of API's definition of an automatic sampling system, the sampler and the programmable control logic (PLC).

Within the custody transfer of a hydrocarbon there is a measured quantity and quality associated with the transmission of product. A meter is typically used to determine the quantity (volume) and a sampler to determine the quality. The automatic fluid sampling system 10 of the present disclosure comprises a device that can take samples of just about any size but preferably takes small repeatable samples, 1-5 cc, in proportion to the flow of the main process line. Preferably, automatic fluid sampling system 10 of the present disclosure is able to maintain a pace of 60 samples/minute with a grab size of 1-5 cc. However, grabbing samples larger than 5 cc will reduce the maximum pace of the system 10. By the end of a custody transfer, an end user will be able to calculate the metered volume and determine an associated quality of that product by analyzing the product collected by the automatic fluid sampling system of the present disclosure.

The automatic fluid sampling system 10 of the present disclosure preferably comprises a flow through “block” manifold 12 comprising a solenoid valve 20, a flow meter 22 (such as a gear-type positive displacement type (PD) or Coriolis flow meter, etc.), used to obtain a sample which is channeled through a sample flow-through conduit (i.e., a channel through which samples are conveyed) defined by manifold 12 and through sample outlet valve 15 which preferably has an open/close lever 16 (a check valve 13 may optionally be used as well).

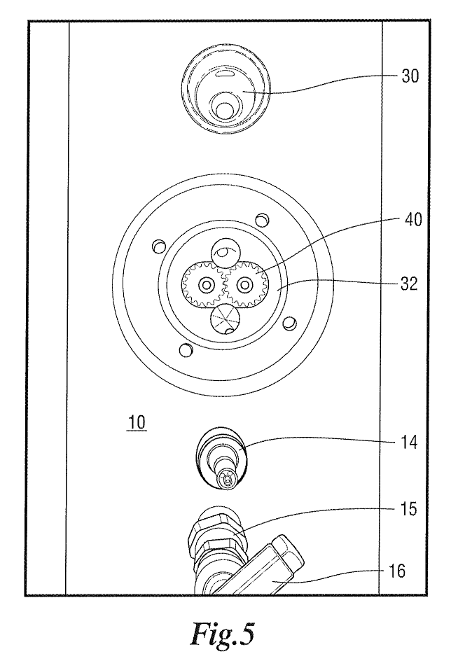

By using a gear-type flow meter 22 (see gears 40 in FIG. 5) to measure/set the sampled amount, pulse sensors used are able to give performance-based feedback to the computer or PLC of system 10. Preferably, more magnets may be employed in the flow meter 22 to increase the resolution of flow meter 22 such that it can accurately measure samples in the 1-5 cc size range. Such additional magnets preferably boost the resolution of the gear-type flow meter 22 by providing for it to output about 13,000 or more pulses per gallon of fluid measured.

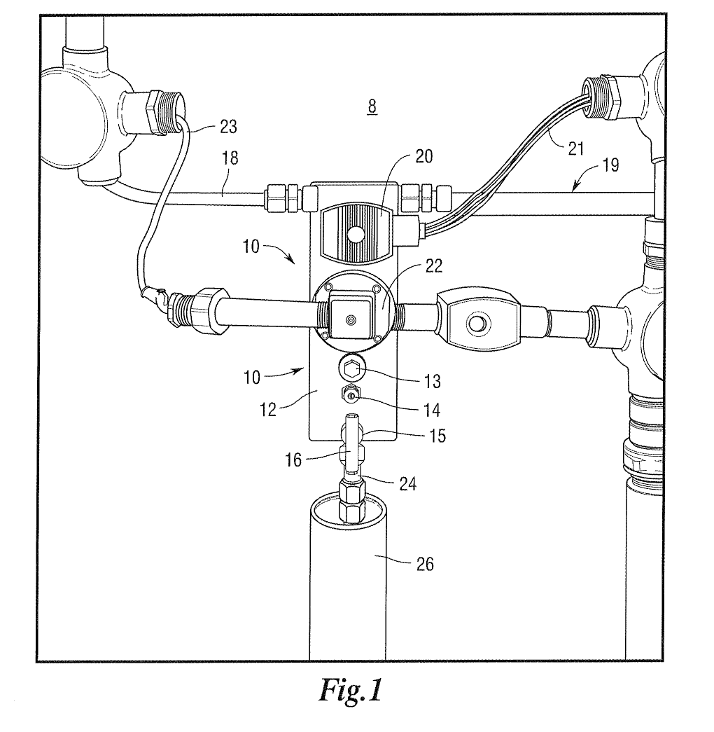

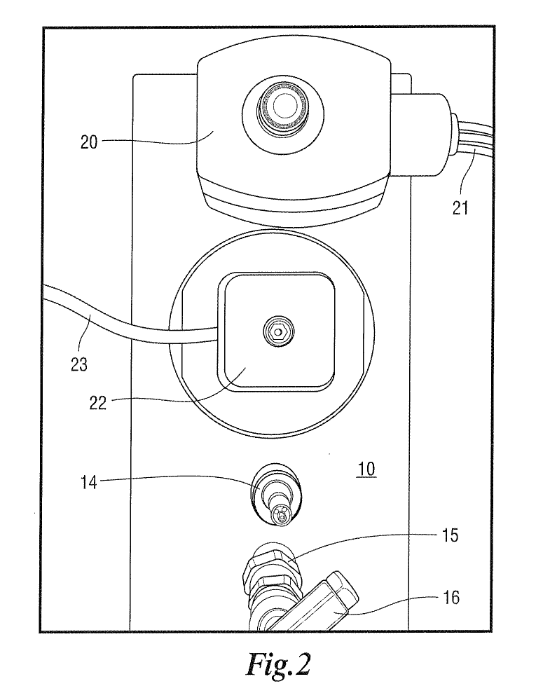

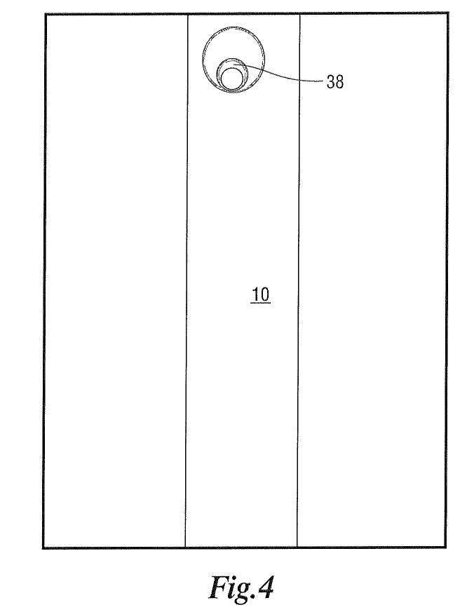

Preferably, the automatic fluid sampling system 10 is “floated on” or connected to the tubing of the fast-loop tubes, 18 and 19. Preferably, the PLC or computer (not shown) of the automatic fluid sampling system 10 of the present disclosure is mounted on a mounting plate 8 disposed near the fluid process line. Power and/or communication lines 21 and 23 connect solenoid valve and flow meter 22, respectively, with the computer of the present disclosure. As shown in FIGS. 1, 2 and 4, fast loop inlet 18 and outlet 19 are connected to manifold 12 in line with fast loop conduit 38 (see FIG. 4). When actuated by the PLC, solenoid valve 20 allows a sample to be extracted from the fast loop conduit 38. The volume of such sample is preferably programmed into the PLC within a range from about 1-5 cc and the frequency for taking such samples may be programmed to occur in proportion to the flow of the main process line from which the fast loop is in fluid communication. Each such sample travels through and is measured by the flow meter 22 on its way through the manifold 12 to a sample container via outlet valve 15, outlet tube 24 and optional tubing 26.

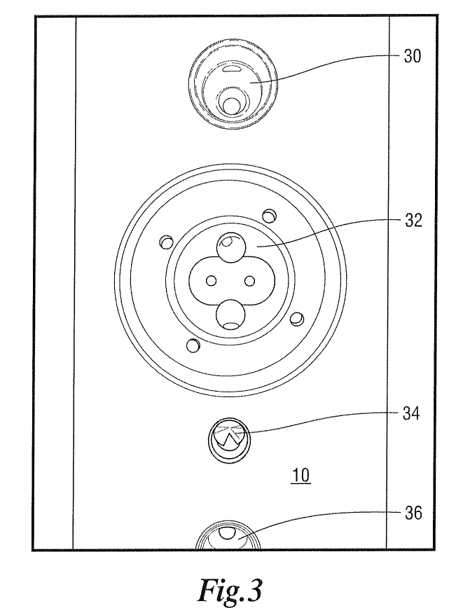

As shown in FIGS. 3-5, manifold 12 defines a solenoid valve cavity 30, meter cavity 32, sampling valve cavity 34, and outlet valve cavity 36. Such cavities are in fluid communication with an inner sample conduit (not shown) defined by the inside of manifold 12.

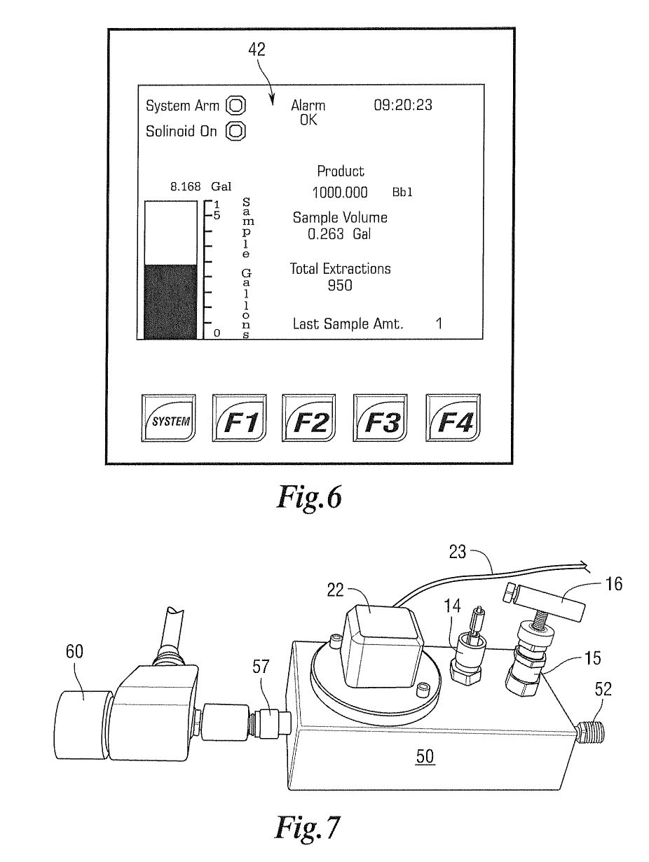

FIG. 6 shows a preferred graphic user interface 42 of the PLC or computer of the automatic fluid sampling system 10 of the present disclosure. As shown, the computer can be used to arm the system and turn the solenoid valve 20 on or off. The amount of transfer product can be input in the system along with the sample volume and the total number of extractions to be taken from the product volume being transferred. The graphic user interface 42 can also display the measured sample volume or sample number for any sample taken. Preferably, once the parameters such as sample size and frequency are set (potentially by another computer system, such as a master control that controls the process line) the automatic fluid sampling system 10 of the present disclosure requires no further inputs or actions by an operator and will function automatically.

FIG. 7 shows a preferred automatic fluid sampling adapter 50 of the present disclosure for use in conjunction with another “dumb” sampling device 60 that can pull samples but doesn't have the metering and/or accounting capabilities of the system 10 of the present disclosure. As shown, the adapter 50 comprises a flow meter 22 disposed in a modified manifold having a sample inlet 51 for connection to sampling device 60. Adapter 50 also comprises a sampling valve 14 and an outlet valve 15 as in the “smart” automatic fluid sampling system 10 described above. Power and/or communication line 23 connects flow meter 22 with the computer of the present disclosure. Once a sample from device 60 is metered through adapter 50 it exits through sample outlet 52 and may be collected in a sample container or otherwise. Again, the particulars of such sample such as volume, sample number, time taken, etc., preferably are recorded by the computer associated with the system 10 of the present disclosure.

The link between the automatic fluid sampling system of the present disclosure and the PLC preferably is not only to pace the sampler, but to monitor the performance of the sampler (operating alarms, # samples extracted, volume extracted, accuracy of extraction amount, etc.) and provide the end user with an all-encompassing batch report (process line metered volume (# bbl), temperature average, pressure average, bs&w average, number of samples taken, volume of samples collected, etc.). Other sensors, meters and/or devices may be associated with other components of the system 10, adapter 50 or related devices such as the process line and/or sample container and connected to the system computer as necessary for obtaining and/or transmitting the information, readings, measurements, and alarms, etc., disclosed herein.

In addition, the automatic fluid sampling system 10 and adapter 50 of the present disclosure have the ability to immediately recognize failures within the system and alert necessary operators by text, email, telephone or other electronic means. The automatic fluid sampling system 10 and adapter 50 of the present disclosure each may provide an accurate sampler (static performance) that communicates with the provided computer/PLC to give the end user the ability to receive the below listed alarms/notifications (dynamic performance): Power failure signal; Flushing of lines between batches; Filling progress—Sample verification; Low-flow or no-flow alarm; Over-fill warning; Sample counter; Sample container switching; Batch calculations; Batch overview report (process line metered volume (# bbl), temperature average, pressure average, bs&w average, number of samples taken, volume of samples collected); Detailed batch report (where the system is programmed to take a 1 cc sample per 5 bbl. The detailed report would produce a spreadsheet confirming when (i.e., the per bbl rate during which samples were taken); and Manual test fire button.

The automatic fluid sampling system 10 of the present disclosure also gives the end user the ability to adjust the sample grab volume (1-5 cc) via PLC input. This capability allows the end user fill the sample container to 80% by the end of an allocation period (as recommended by API). Prior art sampling devices are limited in the volume that can be delivered to the sample container, as sample grab volumes are fixed and not adjustable.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the disclosure.

1. An automatic fluid sampling system, comprising:
a sample flow-through conduit in fluid communication with a fast loop or slip stream off of a fluid process line or pipe,
a solenoid or other valve disposed for regulating fluid flow from the fast loop line into the sample flow-through conduit;
a flow meter in fluid communication with sample flow-through conduit for measuring a volume of a sample allowed to flow through the sample flow-through conduit by the solenoid or other valve; and
a sample fluid outlet from which the sample measured by the flow meter exits the sample flow-through conduit.

2. The automatic fluid sampling system of claim 1 further comprising: a computer or PLC for controlling and/or recording the actions of the solenoid valve and/or the flow meter.

3. The automatic fluid sampling system of claim 2 further comprising: a communications device via which the computer or PLC may be programmed and/or via which the computer or PLC may transmit information such as accounting information for recordings, readings, measurements or actions taken by the system, the solenoid valve and/or flow meter.

4. The automatic fluid sampling system of claim 3 wherein a manifold defines the sample flow-through conduit, in-whole or in-part.

5. The automatic fluid sampling system of claim 3 wherein the information comprises or relates to one or more of the following: Power failure signal; Flushing of lines between batches; Filling progress—Sample verification; Low-flow or no-flow alarm; Over-fill warning; Sample counter; Sample container switching; Batch calculations; Batch overview report (process line metered volume (# bbl), temperature average, pressure average, bs&w average, number of samples taken, volume of samples collected); Detailed batch report (where the system is programmed to take a 1 cc sample per 5 bbl. The detailed report would produce a spreadsheet confirming when (i.e., the per bbl rate during which samples were taken); and Manual test fire button actuation.

6. The automatic fluid sampling system of claim 4 wherein the information comprises or relates to one or more of the following: Power failure signal; Flushing of lines between batches; Filling progress—Sample verification; Low-flow or no-flow alarm; Over-fill warning; Sample counter; Sample container switching; Batch calculations; Batch overview report (process line metered volume (# bbl), temperature average, pressure average, bs&w average, number of samples taken, volume of samples collected); Detailed batch report (where the system is programmed to take a 1 cc sample per 5 bbl. The detailed report would produce a spreadsheet confirming when (i.e., the per bbl rate during which samples were taken); and Manual test fire button actuation.

7. An automatic fluid sample accounting adapter, comprising:
a sample flow-through conduit in fluid communication with a fluid sampling device, wherein samples taken by the fluid sampling device are channeled through the sample flow-through conduit;
a flow meter in fluid communication with sample flow-through conduit for measuring a volume of a sample channeled through the sample flow-through conduit from the fluid sampling device; and
a sample fluid outlet from which the sample measured by the flow meter exits the sample flow-through conduit.

8. The automatic fluid sample accounting adapter of claim 7 further comprising: a computer or PLC for controlling and/or recording the actions of the flow meter.

9. The automatic fluid sample accounting adapter of claim 8 further comprising: a communications device via which the computer or PLC may be programmed and/or via which the computer or PLC may transmit information such as accounting information for recordings, readings, measurements or actions taken by the adapter and/or flow meter.

10. The automatic fluid sample accounting adapter of claim 8 further comprising: a manifold wherein the manifold defines the sample flow-through conduit, in-whole or in-part.

11. The automatic fluid sample accounting adapter of claim 9 further comprising: a manifold wherein the manifold defines the sample flow-through conduit, in-whole or in-part.

12. The automatic fluid sample accounting adapter of claim 9 wherein the information comprises or relates to one or more of the following: Power failure signal; Flushing of lines between batches; Filling progress—Sample verification; Low-flow or no-flow alarm; Over-fill warning; Sample counter; Sample container switching; Batch calculations; Batch overview report (process line metered volume (# bbl), temperature average, pressure average, bs&w average, number of samples taken, volume of samples collected); Detailed batch report (where the system is programmed to take a 1 cc sample per 5 bbl. The detailed report would produce a spreadsheet confirming when (i.e., the per bbl rate during which samples were taken); and Manual test fire button actuation.

13. The automatic fluid sample accounting adapter of claim 10 wherein the information comprises or relates to one or more of the following: Power failure signal; Flushing of lines between batches; Filling progress—Sample verification; Low-flow or no-flow alarm; Over-fill warning; Sample counter; Sample container switching; Batch calculations; Batch overview report (process line metered volume (# bbl), temperature average, pressure average, bs&w average, number of samples taken, volume of samples collected); Detailed batch report (where the system is programmed to take a 1 cc sample per 5 bbl. The detailed report would produce a spreadsheet confirming when (i.e., the per bbl rate during which samples were taken); and Manual test fire button actuation.
